(19) United States
(12) Patent Application Publication
(10) Pub. No.: US 2021/0140564 A1
(43) Pub. Date: May 13, 2021

(54) MOUNTING CLIP FOR PNEUMATIC TUBING

(71) Applicant: LNEJR INNOVATIONS, LLC, New Albany, OH (US)

(72) Inventors: Leo Ruberto, New Albany, OH (US); Eduard Namenyi, New Albany, OH (US)

(21) Appl. No.: 16/679,189

(22) Filed: Nov. 9, 2019

(51) Int. Cl. F16L 3/12; F16L 3/18

(52) U.S. Cl. CPC F16L 3/12; F16L 3/18

(57) ABSTRACT

In accordance with a version of the invention, a multipurpose mounting clip is disclosed for securing a length of pneumatic tubing to a fixed point. The mounting clip for securing a length of pneumatic tubing generally includes a curved central portion forming a semi-circular cross section, an interior member, and an exterior member which is angled towards the interior member axis. Preferably, the mounting clip is configured to attach to the belt of a user.

### FIELD OF THE INVENTION

The present invention relates to the field of pneumatic tubing attachments for use with a nail gun, in particular a mounting clip for supporting pneumatic tubing in multiple configurations.

### BACKGROUND

A roofer, roof mechanic, or roofing contractor is a construction worker who specializes in roof construction. Roofers replace, repair, and install the roofs of buildings, using a variety of materials, including shingles, bitumen, and metal. Roofing work can be physically demanding because it involves heavy lifting, as well as climbing, bending, and kneeling, often in extreme weather conditions.

In order to make roofing more efficient, pneumatic nail guns are often utilized to take the place of traditional hammers by projecting nails at a high rate of speed, thereby greatly reducing labor time. Pneumatic nail guns are designed to provide a hammering force in order to attach shingles to a roof usually constructed of wood or some other kind of material. Pneumatic nail guns utilize compressed air, typically generated by a separate gas-powered air compressor. A standard air compressor works on the same principal as a water pump. It has one or more piston cylinders, which draw air in from the atmosphere on the upstroke and push it out to the gun on the downstroke. This generates a constant supply of compressed air, which flows through a pneumatic tube to the nail gun's air reservoir.

Roofers need to be highly skilled to utilize pneumatic nail guns at elevated heights in order to properly attach shingles without undue hazard of falling. The air compressor is typically located at a lower, ground surface which provides the compressed air via the pneumatic tubing to the roofer's nail gun at the heightened level. From the roofer's perspective, tubing slack can be awkward to manage and the tubing collectively heavy to move while moving about the roof. Often, because tubing is untethered between the compressor and the nail gun, roofers become entangled with or even trip over tubing causing an undue safety hazard at an elevated position, which comes with risks of severe bodily injury or even death if a roofer should fall from the elevated position.

For the foregoing reasons, there is a need for an improved pneumatic tubing attachment which provides tube stability and control while moving about an elevated surface.

### SUMMARY

[Summary Based on Final Claim Suite Here]

These and other features of the present invention will become readily apparent upon further review of the following specification and drawings.

### BRIEF DESCRIPTION OF THE DRAWINGS

These and other features, aspects, and advantages of the present invention will become better understood with regard to the following description and accompanying figures where:

FIG. 1 is a front perspective view of a version of the application;

FIG. 2 is a front perspective view of the version shown in FIG. 1;

FIG. 3 is a front elevation view of the version shown in FIG. 1;

FIG. 4 is a rear elevation view of the version shown in FIG. 1;

FIG. 5 is a left side elevation view of the version shown in FIG. 1;

FIG. 6 is a right side elevation view of the version shown in FIG. 1;

FIG. 7 is a bottom plan view of the version shown in FIG. 1;

FIG. 8 is a top plan view of the version shown in FIG. 1;

FIG. 9 is a rear side cut away view of the version shown in FIG. 1;

FIG. 10 is a front side cutaway view of the version shown in FIG. 1;

FIG. 11 is a sectional view of the version shown in FIG. 5 taken along lines A-A;

FIG. 12 is a sectional view of the version shown in FIG. 6 taken along lines B-B;

FIG. 13 is an illustrative view showing a first operation of the version shown in FIG. 1;

FIG. 14 is an illustrative view showing a second operation of the version shown in FIG. 1;

FIG. 15 is a detailed view taken from FIG. 14 showing the second operation of the version shown in FIG. 1;

FIG. 16 is a detailed view taken from FIG. 14 showing a third operation of the version shown in FIG. 1;

FIG. 17a is an illustrative view showing the third operation of the version shown in FIG. 1;

FIG. 17b is an illustrative view showing the third operation of the version shown in FIG. 17a;

FIG. 18 is a side elevation view showing the third operation of the version shown in FIG. 16; and

FIG. 19 is an illustrative view showing a fourth operation of the version shown in FIG. 1; and

FIG. 20 is a side elevation view showing the fourth operation of the version shown in FIG. 19.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other versions that depart from these specific details. In other instances, detailed descriptions of well-known devices, circuits, and methods are omitted so as not to obscure the description of the present invention with unnecessary detail.

Moreover, the description is not to be taken in the limiting sense but is made merely for the purpose illustrating the general principles of the invention, since the scope of the invention is best defined by the appended claims. Various inventive features are described below that can each be used independently of one another or in combination with other features.

Unless otherwise defined, all technical terms used herein have the same meaning as commonly understood by one of ordinary skill in the art to which the invention belongs. As used in the specification and the appended claims, the singular forms “a,” “an,” and “the” include plural references unless the context clearly dictates otherwise. Any reference to “or” herein is intended to encompass “and/or” unless otherwise stated.

With reference to the figures, a description of a version of the invention will be provided and is generally designated as numeral 10. Generally speaking, the application is directed towards a multipurpose mounting clip 10 for securing a length of pneumatic tubing 90. Primarily, the mounting clip 10 is designed to attach pneumatic tubing 90 to the side of a user by way of the user's belt or waistband. Alternatively, the mounting clip 10 is also configured to be mounted to a myriad of surfaces for securing and managing pneumatic tubing 90 during operation of a nail gun or other pneumatic tool 94, for example securing the pneumatic tubing 90 to an elevated roof 92 (See FIG. 14 and FIG. 15) or attachment to a wall or framework 100 (See FIG. 13). Put simply, the mounting clip 10 allows the user to free up an extra hand in order to safely navigate the rooftop surface 96 while utilizing pneumatic tools 94 (See FIG. 14). For example, the user's hip is the established connection point as opposed to the user's hand, thereby inherently improving both work efficiency and, more importantly, safety while on the job.

With reference to FIG. 1 and FIG. 2, in a version of the application, the mounting clip 10 generally comprises a curved central portion 12 forming a channel 14, an interior member 16 integrally extending downward from the rear of the central curved portion 12, and an exterior member 18 integrally extending downward from the front of the central curved portion 12. Generally, the interior member 16 and the exterior member 18 are aligned and angled to form a narrowing interior gap 20 leading from the channel 14 to a clip entrance 22. In certain versions, the mounting clip 10 is formed of a molded plate having a unitary continuous construction.

By way of background, most standard pneumatic tubing 90 has an outside diameter of 1 inch or less, with common outside diameters ranging from ⅛^{th} to ½ inches. With reference to FIG. 5, FIG. 6, and FIG. 18, the curved central portion 12 is operably configured to receive a length of pneumatic tubing 90 having an outside diameter. The curved central portion 12 generally forms a downward opening channel 14 extending between an interior end 24 and an exterior end 26. The channel 14 having a tubular semi-circular cross section extending the width of the curved central portion 12 and having a longitudinal axis X (See FIG. 4). The channel 14 configured to partially envelope the longitudinal cylindrical shape of the pneumatic hose (See FIG. 20). Preferably, the interior diameter D1 of the channel 14 semi-circular cross section is preferably 0.5-1 inches, ideally 0.625 inches in order to accommodate variable sized pneumatic tubing 90 diameters.

As best illustrated by FIG. 4 and FIG. 5, the interior member 16 generally forms a vertical planar wall structure defined between a proximal end 28 and a distal end 30. The interior member 16 integrally extends downward from the interior end 24 of the curved central portion 12 along an interior member 16 axis Yᵢ and terminating at the distal end 30. The interior member 16 generally functions to provide the mounting clip 10 support and stability when mounted to a structure, whether a wall, roof, belt, or waistband. For example, the mounting clip 10 is secured to a user by inserting the planar interior member 16 over and behind the user's belt 98 while still exposing the curved central portion 12 and the exterior member 18 exterior of the user's belt 98 (See FIGS. 17a and 17b).

In certain versions and as best illustrated by FIG. 4, the interior member 16 may generally have a flared profile in order to provide improved lateral support, particularly while the mounting clip 10 experiences rotational forces caused by pneumatic tubing 90 and user movement. In the illustrated version, the interior member 16 comprises an upper portion 32 having a constant width W_{U}, a base portion 34 having a constant width W_{b}, and a central expanding portion 36 extending between the base portion 34 and the upper portion 32. In the version, the base portion 34 width W_{b} is greater than the upper portion 32 width W_{U} in order to provide a flared profile for superior lateral support. Therebetween, the central expanding portion 36 integrally expands in width from the upper portion 32 width W_{U} to the greater base portion 34 width W_{B}. Preferably, the base portion width W_{b} is between 2-3 inches, more preferably, 2.65 inches. Preferably, the upper portion width W_{U} is between 1.5-2.5 inches, more preferably, 2.165 inches. Preferably, the interior member 16 length L_{I} is between 3-4 inches, more preferably 3.5 inches.

Referring to FIG. 3-FIG. 7, the exterior member 18 is generally a planar wall structure defined between a proximal end 38 and a distal end 40. The exterior member 18 integrally extends length Lₑ from the interior end 26 of the curved portion 12 along an exterior member axis Yₑ to the exterior member 18 distal end 40. In the version, the exterior member axis Y_{E} is angled with respect to the interior member axis Y_{I}. In other words, the exterior member 18 extends downward and towards the interior member at an acute angle Z forming the basic structure of the mounting clip. Preferably the acute angle Z is between 10-20 degrees, preferably about 16 degrees. The distal end 40 of the exterior member 18 and the interior surface 42 of the interior member 16 forming the lateral boundaries of a narrowing interior gap 20 terminating at the clip entrance 22. Preferably, the clip entrance 22 provides at least a minimal clearance depth of 0.0425 inches, preferably 0.0625 inches. Preferably, the width W_{E} of the exterior member 18 is constant along its length between 1.5-2.5 inches, more preferably, 2.165 inches. In the illustrated version, the exterior member 18 width W_{E} is equal to the interior member 16 upper portion 32 width W_{U}. Moreover, the length L_{E} of the exterior member 18 is preferably less than the length L_{I} of the interior member 16. Preferably, the length L_{E} (See FIG. 3) is between 1.5-2.5 inches, more preferably approximately 2 inches.

Referring specifically to FIG. 3, FIG. 6, and FIG. 7, in a version of the application, the exterior member 18 distal end 40 has a flange 44 which extends angled away from the interior member 16. The flange 44 assists with initial attachment of the pneumatic tubing 90 to the mounting clip 10 through the clip entrance 22 by pushing the exterior member 18 away from interior member 16. In detail, the flange 44 functions to help grip and guide the longitudinal length of pneumatic tubing 90 through the clip entrance 22 and into the narrowing interior gap 20 in the attachment process. Ideally, the plane of the flange 44 is oriented at approximately 45 degrees from the plane or axis Y_{I} of the interior member 16.

In certain versions of the application, as best illustrated by FIG. 6 and FIG. 9, either of the mounting clip 10 interior member 16 and/or the exterior member 18 inner surfaces 42, 46 may boast a plurality of laterally extending raised surface grips 48. Preferably, as shown, at least the exterior member 18 inner surface 46 provides the raised surface grips 48 in order to accommodate various sized pneumatic tubing 90 diameters D₁ and to retain pneumatic tubing 90 positioning within the mounting clip 10 (See FIG. 18).

With reference to FIG. 3 and FIG. 4 generally, a version of the mounting clip 10 may optionally further include an integral keyhole 50 having a larger circular aperture 52 merging with a smaller circular aperture 54. The keyhole 50 is operably configured to receive a linear object therethrough such as a nail or hook 102, thereby allowing attachment of the mounting clip 10 to a wall or other surface. For example, FIG. 13 illustrates how a plurality of mounting clips 10 can be utilized to elevate and secure a length of pneumatic tubing 90 to a vertical structure such as a wall or other framework 100. As illustrated, each of the mounting clips 10a, 10b are inverted such that the mounting clip 10 supports and hangs the pneumatic tubing 90 below the keyhole 50 which is configured to receive and seat on a nail, screw, etc.

FIG. 14 and FIG. 15 show how the mounting clip 10 can be used to secure a primary line of pneumatic tubing 90 from the ground to an elevated roof structure 92. Thereafter, the line of pneumatic tubing 90 can diverge into separate lines 90a, 90b, 90c which provide pneumatic air to multiple concurrently used pneumatic tools 94.

As illustrated in FIG. 16, the mounting clip 10 can easily be attached to any object or bag 104 which has an upper rim 106, such as a roofer's tool bag.

FIG. 17a and FIG. 17b illustrate how the mounting clip 10 operates to secure a length of pneumatic tubing 90 to the user's belt 98. First, the mounting clip 10 is positioned over the upper rim 108 of the belt 98 exposing the curved central portion 12 above the belt 98 upper rim 108. The curved central portion 12 biases the angled exterior member 18 towards the interior member 16 thereby pinching the user's belt 98 therebetween. Thereafter, the length of pneumatic tubing 90 is positioned via the clip entrance 22 and positioned within the narrowing interior gap 20 below the curved central portion 12 channel 14, pinching or securing the length of pneumatic tubing 90 between the exterior member 18 interior surface 46 and the exterior surface 99 of the user's belt 98. Further as detailed in FIG. 18, the length of pneumatic tubing 90 is vertically positioned between two adjacent laterally extending raised surface grips 48. At this point, the length of pneumatic tubing 90 is securely attached to the user's side, preventing the user from accidently dropping or even tripping over the pneumatic tubing 90 while at an elevated position.

With reference to FIG. 19 and FIG. 20, Because the inner radius of the curved central portion 12 is slightly larger than the radius of the preferred pneumatic tubing 90, the user can freely translate the pneumatic tubing 90 by positioning it through the channel 14 having a semi-circular cross section, thus allowing the ability to further manipulate positioning of the pneumatic tubing 90 and to move about the elevated surface such as a roof.

Generally, the mounting clip 10 can be made in any manner and of any material chosen with sound engineering judgment. Preferably, materials will be strong, lightweight, long-lasting, economic, ergonomic, and buoyant. Preferably, the mounting clip 10 is constructed of a resilient material such as metal, plastic, or a composite. Further, it is preferable that the mounting clip 10 be formed of a unitary continuous plate construction and/or molded into the described configuration.

The invention does not require that all the advantageous features and all the advantages need to be incorporated into every version of the invention.

Although preferred embodiments of the invention have been described in considerable detail, other versions and embodiments of the invention are certainly possible. Therefore, the present invention should not be limited to the described embodiments herein.

All features disclosed in this specification including any claims, abstract, and drawings may be replaced by alternative features serving the same, equivalent or similar purpose unless expressly stated otherwise.

1-20. (canceled)

21. A mounting clip for securing a length of pneumatic tubing having a diameter, the mounting clip comprising:
a curved central portion forming a semi-circular cross section having an axis, the curved central portion having an interior end and an exterior end;
an interior member having a proximal end and a distal end, the interior member integrally extending from the interior end of the curved central portion along an interior member axis to the interior member distal end, the interior member comprising an upper portion, a base portion, and a central expanding portion extending between the upper portion and the base portion, wherein the upper portion having a width and the base portion having a width being greater than the upper portion width, the central expanding portion expanding in width from the upper portion width to the base portion width;
an exterior member having an interior surface, a proximal end, and a distal end, the exterior member integrally extending from the exterior end of the curved central portion along an exterior member axis to the exterior member distal end, wherein the exterior member axis is angled towards the interior member axis; and
a flange integral with the exterior member distal end and extending away from the interior member;
wherein the interior member has a longitudinal length and the exterior member has a long longitudinal length, the interior member longitudinal length being greater than the exterior member longitudinal length;
wherein the base portion of the of the interior member is positioned beyond the distal end of the exterior member.

22. The mounting clip of claim 21, wherein the angle formed between the interior member axis and the exterior member axis is between 10-20 degrees.

23. The mounting clip of claim 22, wherein the semi-circular cross section has a diameter of approximately 0.5 to 1 inch.

24. The mounting clip of claim 23, wherein the interior member further comprises a keyhole integrally positioned near the interior member distal end.

25. The mounting clip of claim 24, wherein the exterior member further comprises an interior surface having a plurality of laterally extending raised surface grips.

26. The mounting clip of claim 21, wherein the central expanding portion and the base portion of the interior member are positioned beyond the distal end of the exterior member.

27. The mounting clip of claim 26, wherein the exterior member has a constant width along the exterior member longitudinal length and wherein the base portion width is greater than the exterior member width.

28. A mounting clip for securing a length of pneumatic tubing having a diameter, the mounting clip comprising:
a curved central portion forming a semi-circular cross section having an axis, the curved central portion having an interior end and an exterior end;
an interior member having a proximal end and a distal end, the interior member integrally extending from the interior end of the curved central portion along an interior member axis to the interior member distal end, the interior member comprising an upper portion and a base portion;
an exterior member having a width, an interior surface, a proximal end, and a distal end, the exterior member integrally extending from the exterior end of the curved central portion along an exterior member axis to the exterior member distal end, wherein the exterior member axis is angled towards the interior member axis; and
a flange integral with the exterior member distal end and extending away from the interior member;
wherein the interior member has a longitudinal length and the exterior member has a long longitudinal length, the interior member longitudinal length being greater than the exterior member longitudinal length;
wherein the interior member upper portion having a width and the interior member base portion having a width, the width of the base portion being greater than the width of the upper portion;
wherein the width of the interior member base portion is greater than the width of the exterior member;
wherein the base portion of the of the interior member is positioned beyond the distal end of the exterior member.

29. The mounting clip of claim 28, wherein the angle formed between the interior member axis and the exterior member axis is between 10-20 degrees.

30. The mounting clip of claim 29, wherein the semi-circular cross section has a diameter of approximately 0.5 to 1 inch.

31. The mounting clip of claim 30, wherein the interior member further comprises a keyhole integrally positioned near the interior member distal end.

32. The mounting clip of claim 31, wherein the exterior member further comprises an interior surface having a plurality of laterally extending raised surface grips.
